(19) United States
(12) Patent Application Publication
(10) Pub. No.: US 2011/0004731 A1
(43) Pub. Date: Jan. 6, 2011

(54) CACHE MEMORY DEVICE, CACHE MEMORY SYSTEM AND PROCESSOR SYSTEM

(75) Inventor: Hideyo TSURUTA, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/883,320

(22) Filed: Sep. 16, 2010

Related U.S. Application Data
(63) Continuation of application No. PCT/JP2009/001406, filed on Mar. 27, 2009.

(30) Foreign Application Priority Data
Mar. 31, 2008 (JP) 2008-092472

(51) Int. Cl. G06F 12/08; G06F 12/00

(52) U.S. Cl. 711/146; 711/141; 711/E12.001; 711/E12.026

(57) ABSTRACT

A cache memory device includes: a storage unit in which data and attribute information can be stored in association with each other; and a cache controller which (i) obtains, from CPU, a request signal requesting access to data and an indication signal indicating whether or not the requested data is a synchronization primitive, and when the indication signal indicates that the data requested by the request signal is the synchronization primitive, (ii) stores in association, into the storage unit, the requested data and synchronization primitive attribute information indicating that the requested data is a valid synchronization primitive. The cache controller prohibits purge of the data stored in the storage unit in association with the synchronization primitive attribute information.

### CROSS REFERENCE TO RELATED APPLICATION

This is a continuation application of PCT application No. PCT/JP09/001406 filed Mar. 27, 2009, designating the United States of America.

### BACKGROUND OF THE INVENTION

(1) Field of the Invention

The present invention relates to cache memory devices and, in particular, to a technique for improving efficiency of access to data which is used as a synchronization primitive.

(2) Description of the Related Art

In recent computer systems which are required to exhibit high performance, parallel processors have been introduced in various grain levels. For example, single instruction multiple data (SIMD), very long instruction word (VLIW), superscalar and the like have been widely in practical use in order to achieve instruction-level parallelism, multithread processing, multitask processing and the like have been widely in practical use in order to achieve instruction-level parallelism and furthermore, multiprocessor structures, multicore structures and the like have been widely in practical use in order to achieve LSI-level parallelism.

In the computer systems, when one or more processors execute multiple processes in parallel and a single resource is shared among the multiple processes, various techniques are used to synchronize the processes.

Here, to synchronize the processes means to preserve the order of access from the multiple processes to the shared resource so as to obtain a desired processing result.

For example, Japanese Unexamined Patent Application Publication No. 4-279960 discloses a technique of synchronizing processes in which technique one or more processors executing multiple processes in parallel utilize local caches connected to the respective processors to reduce access to a shared memory.

This technique uses a barrier instruction to synchronize the processes. The barrier instruction preserves the order of access by suspending execution of the processors according to the need.

As a technique for synchronizing the processes, another widely practiced technique is to provide a synchronization primitive corresponding to the shared resource so that among multiple processes, a process which succeeded in updating the synchronization primitive will be given exclusive access to the shared resource.

In this technique, only the process which confirmed that the synchronization primitive had been not in use and then successfully updated it to “in-use” status is able to enter a critical section that is a processing period in which an exclusive use of the corresponding shared resource is allowed. Semaphore and Mutex are an example of the synchronization primitive.

For the multiple processes to update the synchronization primitive without conflict, read-modify-write operation on the synchronization primitive needs to be atomic (indivisible).

Because of the indivisibility of atomic operation, the atomic operation in the multiple processes cannot be executed in parallel, which means that as a period for the atomic operation on the synchronization primitive is longer, the parallelism of the processes deteriorates, which negatively affects system throughput.

To deal with this, Japanese Unexamined Patent Application Publication No. 9-138778 discloses a technique in which semaphore buffers are provided for respective multiple processors, which operate in parallel, so that updating semaphore is executed in parallel in the respective semaphore buffers.

Another literature “32 bit power PC architecture programming so environment, Freescale semiconductor, Reference Manual, MPCFPE32BJ Rev. 1, 12/2005 (originally MPCFPE32B Rev. 3)” discloses computer architecture including a memory reference instruction lwarx with an instruction to obtain a reservation as an update right, and a conditional memory update instruction stwcx. to update the semaphore only when the reservation has been obtained.

In this computer architecture, the lwarx instruction and the instruction stwcx. are repeated until the instruction stwcx. is successfully executed, which enables equivalently atomic read-modify-write operation. The period for the atomic operation is subdivided, with the result that the negative impact on the system throughput will be mitigated.

The following will describe one specific example of a multiprocessor system capable of operating for the reservation defined by the lwarx instruction and the instruction stwcx. In the description, a data cache has a general structure which is commonly well-known because the lwarx instruction and the instruction stwcx. do not specifically define data cache operation.

FIG. 1 is a block diagram showing a functional structure of the multiprocessor system. The multiprocessor system shown in FIG. 1 is implemented as a semiconductor system LSI (SoC) or an information appliance set, for example.

In FIG. 13, a central processing unit (CPU) 111 and a central processing unit (CPU) 121 are each an information processing circuit which loads a program, which is an instruction set, from an instruction cache memory device (ICACHE) 112 or an instruction cache memory device (ICACHE) 122, and executes the instructions, being referred to as a microprocessor or simply a processor.

The CPU 111 includes, as an example, a fetch and decoding unit (FETCH/DEC) 114 that loads an instruction from the ICACHE 112, an execution unit (EXEC) 115 that executes the decoded instruction, and a register unit (REG) 116 having multiple registers.

Likewise, the CPU 112 includes a FETCH/DEC 124 that loads an instruction from the ICACHE 122, an EXEC 125, and a REG 126.

The ICACHE 112 is a buffer which preloads a program stored in a main memory (MEM) 106, and temporarily holds the program to supply an instruction stream fast to the CPU 111 via an instruction signal line 117.

Likewise, the ICACHE 122 is a buffer which preloads a program stored in the MEM 106, and temporarily holds the program to supply an instruction stream fast to the CPU 121 through an instruction signal line 127.

A data cache memory device (DCACHE) 113 is a buffer which preloads a program stored in the MEM 106, and temporarily holds the program to supply data fast to the CPU 111. The DCACHE 113 temporarily holds data which the CPU 111 is to write into the MEM 106, and the CPU 111 later writes the data into the MEM 106 at an appropriate time. The DCACHE 113 executes this operation according to an access request signal provided from the EXEC 115 of the CPU 111 through a request signal line 118.

The DCACHE 123 also executes operation of the same sort as the operation executed by the DCACHE 113, according to an access request signal provided from the EXEC 125 of the CPU 121 through a request signal line 128.

The DACHE 113 and the DCACHE 123 are each implemented with a commonly well-known structure (not shown) represented by a 4-way set associative, for example.

In FIG. 1, the CPU 111 and the CPU 121 may be functionally heterogeneous or homogeneous. The ICACHE 112 and ICACHE 122 may be different in capacity, structure, and performance, and the DCACHE 113 and DCACHE 123 may be different in capacity, internal structure, and performance.

A bus control unit (BCU) 101 is a bus control unit which controls data transfer between multiple blocks connected to a shared bus 104.

The shared bus 104 is a bus which is connected to multiple blocks and includes an address, a data line, a control signal, and the like to transfer data between the multiple blocks. This bus is time-shared. Of the blocks connected at a certain moment, one block becomes the master and transfers data to another block which serves as a slave.

A memory control unit (MCU) 105 is an interface for the CPU 111, the CPU 121, and other masters to read/write data from/to the MEM 106.

The MEM 106 is a semiconductor memory such as a dynamic random access memory (DRAM), a ferroelectric RAM (FeRAM), a resistive RAM (ReRAM), and a flash memory, and stores data, programs, and the like which are to be processed by the CPU 111 and the CPU 121.

The MEM 106 operates slower than the CPU 111 and the CPU 121, and to compensate for this difference in operation speed, the ICACHE 112, DCACHE 113, ICACHE 122, and DCACHE 123 which are higher in speed and smaller in capacity than the MEM 106 are provided.

In recent years, the difference in operation speed between the CPUs 111, 112 and the MEM 106 becomes greater, making the access to the MEM 106 a bottleneck for system performance.

A peripheral circuit (PERIPHERAL) 107 and a peripheral circuit (PERIPHERAL) 108 are blocks which are connected to the shared bus 104 and provide part of auxiliary functions of the CPU 111. In the PERIPHERALs 107 and 108, various functions are provided such as an interrupt control, a direct memory access controller (DMAC), an external interface, a timer, a counter, a reset control, an A/D converter, a D/A converter, and a serial IO.

A snoop bus 103 connects the DCACHE 113, the DCACHE 123, and a snoop controller (SNPC) 102, and is used to transfer data between the DCACHE 113 and the DCACHE 123.

The SNPC 102 is connected to the snoop bus 103 and the shared bus 104, and maintains data coherency in the DCACHE 113 and the DCACHE 123 by controlling data transfer between the DCACHE 113, the DCACHE 123, and the MEM 106 according to an access request which is given to the DCACHE 113 and the DCACHE 123. The SNPC 102 includes functions of cache controller for the DCACHE 113 and the DCACHE 123.

The following will describe one example of specific operation in the case where the CPU 111 and the CPU 121 perform contentious update processing on the synchronization primitive for the same shared resource in the multiprocessor system structured as above. In the following description, the synchronization primitive is a semaphore.

The CPU 111 executes the lwarx instruction to load data (semaphore) located at a predetermined address (called as a semaphore address). A copy of the semaphore in the MEM 106 is provided to the DCACHE 113 through the shared bus 104 and then stored in the DCACHE 113. The semaphore stored in the DCACHE 113 is provided to the CPU 111.

In order to indicate that a reservation has been obtained in the CPU 111, a RESERVE bit in the REG 116 is set.

The SNPC 102 starts to monitor the update operation which the CPU 111 and CPU 121 perform on the semaphore address.

The CPU 121 executes the lwarx instruction to load the semaphore located at the same semaphore address. The semaphore in the MEM 106 is provided to the DCACHE 123 through the shared bus 104 and then stored in the DCACHE 123, or alternatively, the semaphore in the DCACHE 113 is provided by the SNPC 102 to the DCACHE 123 through the snoop bus 103 and then stored in the DCACHE 123.

In order to indicate that a reservation has been obtained in the CPU 121, a RESERVE bit in the REG 126 is set.

The SNPC 102 continues to monitor the update operation which the CPU 111 and the CPU 121 perform on the semaphore address.

The CPU 111 and the CPU 121 calculate the first value and the second value, respectively, for updating the semaphore.

The CPU 111 executes the instruction stwcx. to store the first value in the semaphore address. Because the RESERVE bit in the REG 116 has been set, the semaphore in the DCACHE 113 is rewritten with the first value.

If the semaphore is purged from the DCACHE 113, the semaphore in the MEM 106 is provided to the DCACHE 113 through the shared bus 104 and then stored in the DCACHE 113, or alternatively, the semaphore in the DCACHE 123 is provided by the SNPC 102 to the DCACHE 113 through the snoop bus 103 and then stored in the DCACHE 113, and thereafter, the stored semaphore is rewritten with the first value. The CPU 111 thus obtains a right of access to the shared resource.

When the DCACHE 113 is write-through, the first value is immediately written into the MEM 106. When the DCACHE 113 is write-back, the first value is later written into the MEM 106 according to the need.

In order to indicate that the reservation has been cleared in the CPU 111, the RESERVE bit in the REG 116 is cleared.

The SNPC 102 detects that the CPU 111 has updated the semaphore in the DCACHE 113 to the first value, and then invalidates the semaphore in the DCACHE 123 or updates the semaphore in the DCACHE 123 to the first value, through the snoop bus 103.

Furthermore, the SNPC 102 clears the RESERVE bit in the REG 126 in the CPU 121 through a signal line 129 in order to indicate that the reservation has been cleared in the CPU 121.

The CPU 121 executes, later than the CPU 111, the instruction stwcx. to store the second value in the semaphore address. Because the RESERVE bit in the REG 126 has been cleared, no effective operation for storing the second value is performed, with the result that the CPU 121 does not obtain the right of access to the shared resource.

As described above, when one of the CPU 111 and the CPU 121 updates the semaphore, the SNPC 102 controls so that the RESERVE bit in the other of the CPU 111 and the CPU 121 is cleared through a signal line 119 or the signal line 129, with the result that the semaphore will not be updated by the instruction stwcx. executed later.

Thus, of the CPU 111 and the CPU 121, only one that executes the instruction stwcx. first obtains the right of access to the shared resource and thereby becomes able to exclusively access the shared resource, which allows for synchronization of the processes.

### SUMMARY OF THE INVENTION

In the above multiprocessor system, upon purging the semaphore from the DCACHE 113 and the DCACHE 123, the semaphore is written back to the MEM 106. Moreover, to access the semaphore again after the purge, the semaphore is read out from the MEM 106 to the DCACHE 113 and the DCACHE 123.

These operations will impose an overhead on not only a multiprocessor system but also a single processor system which holds a synchronization primitive (semaphore) in a cache.

However, no cache memory devices have been known which take an effective measure to reduce the frequency of these operations.

The present invention has been made in view of the circumstances as above, and an object of the present invention is to provide a cache memory device which stores a synchronization primitive and reduces the above-mentioned overhead.

In order to solve the above problems, the cache memory device according to an aspect of the present invention is a cache memory device which stores a copy of data to be stored in a main memory and provides the copy as accessed from a central processing unit, the cache memory device including: a storage unit in which the data and attribute information can be stored in association with each other; an obtaining unit configured to obtain a request signal and an indication signal from the central processor, the request signal requesting access to the data, and the indication signal indicating whether or not the requested data is a synchronization primitive; and a control unit configured to store, into the storage unit, the requested data and synchronization primitive attribute information in association when the indication signal indicates that the data requested by the request signal is the synchronization primitive, the synchronization primitive attribute information indicating that the requested data is a valid synchronization primitive.

Furthermore, the control unit may prohibit purge of the data stored in the storage unit in association with the synchronization primitive attribute information.

Furthermore, the control unit may perform an atomic operation in response to the request signal, to store, into the storage unit, the requested data and the synchronization primitive attribute information in association with each other.

Furthermore, the present invention may be implemented as a processor system including: the above cache memory device; and a central processor which provides a request signal and an indication signal to the cache memory device in executing a specific instruction, the request signal requesting access to data indicated by the specific instruction, and the indication signal indicating that the requested data is a synchronization primitive.

Furthermore, the present invention may be implemented as a cache memory system including: the above two cache memory devices; and a snoop device connected to the first cache memory device and the second cache memory device, the snoop device (i) monitoring a request signal and an indication signal which are provided to each of the cache memory devices, and when the request signal and the indication signal are detected, (ii) making an adjustment according to the detected request signal and the detected indication signal such that coherency of data and synchronization primitive attribute information stored in each of the cache memory is devices is maintained.

Furthermore, the snoop device may perform an atomic operation in response to the detected request signal, to make the adjustment such that the coherency of the data and the synchronization primitive attribute information stored in each of the cache memory devices is maintained.

Furthermore, the present invention may be implemented as a processor system including the above cache memory system; and more than one central processor which is provided to a corresponding one of cache memory devices included in the cache memory system and provides a request signal and an indication signal to the corresponding one of cache memory devices in executing a specific instruction, the request signal requesting access to data indicated by the specific instruction, and the indication signal indicating that the requested data is a synchronization primitive.

The present invention has an effect of reducing an overhead relating to operations on a synchronization primitive for mutual exclusion control between multiple processors or multiple threads, as compared to the conventional techniques. When a CPU executes a specific instruction including a data access request, synchronization primitive attribute information is held in a cache memory device according to an indication signal given by the CPU so that the synchronization primitive is continuously present in the cache memory device, which allows for improvement in performance of synchronous processing between processes in a general processor architecture.

### FURTHER INFORMATION ABOUT TECHNICAL BACKGROUND TO THIS APPLICATION

The disclosure of Japanese Patent Application No. 2008-092472 filed on Mar. 31, 2008 including specification, drawings and claims is incorporated herein by reference in its entirety.

The disclosure of PCT application No. PCT/JP09/001406 filed, Mar. 27, 2009, including specification, drawings and claims is incorporated herein by reference in its entirety.

### BRIEF DESCRIPTION OF THE DRAWINGS

FIG. 1 is a block diagram showing a functional structure of a conventional multiprocessor system.

FIG. 2 is a block diagram showing one example of a functional structure of a single processor system according to the first embodiment.

FIG. 3 shows one example of a synchronization primitive operation instruction.

FIG. 4 is a block diagram showing one example of detailed structures of a CPU and a cache memory.

FIG. 5 shows one example of a cache control signal.

FIG. 6 shows one example of operation of the CPU and the cache memory.

FIG. 7 is a block diagram showing another example of a functional structure of the cache memory.

FIG. 8 is a sequence chart for explaining one usage example of the synchronization primitive operation instruction.

FIG. 9 is a block diagram showing one example of a functional structure of a multiprocessor system according to the second embodiment.

FIG. 10 shows one example of operation of a CPU, a cache memory, and an SNPC.

FIG. 11 is a sequence chart for explaining one usage example of the synchronization primitive operation instruction.

FIG. 12 shows another example of operation of the CPU, the cache memory, and the SNPC.

FIG. 13 is a sequence chart for explaining one usage example of the synchronization primitive operation instruction.

### DESCRIPTION OF THE PREFERRED EMBODIMENT(S)

In the following description, a processor system of the present invention is exemplified as a widely prevalent and general information processing system. In the following embodiments, as instruction-level parallel processing, a single processor structure uses multithread processing, and a multiprocessor (multicore) structure uses multiprocessor processing or multiprocessor processing and multithread processing.

### First Embodiment

First, a processor system according to the first embodiment is described.

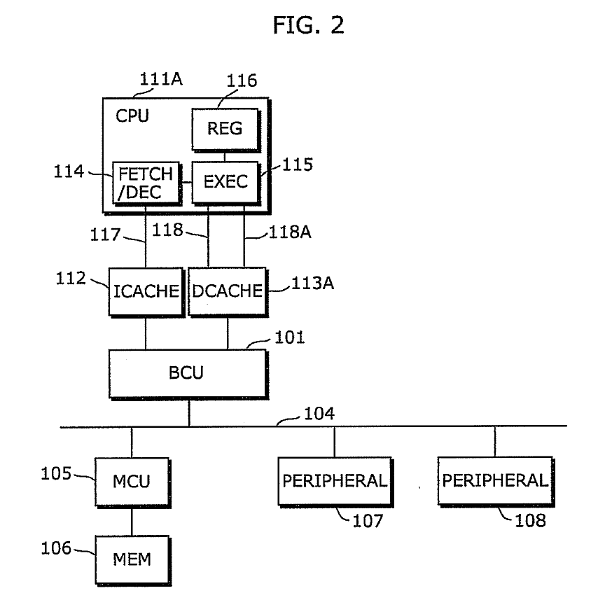

FIG. 2 is a block diagram showing one example of a functional structure of the multiprocessor system according to the first embodiment. This processor system includes one parallel processor. The processor system shown in FIG. 2 is implemented as a semiconductor system LSI (SoC) or an information appliance set.

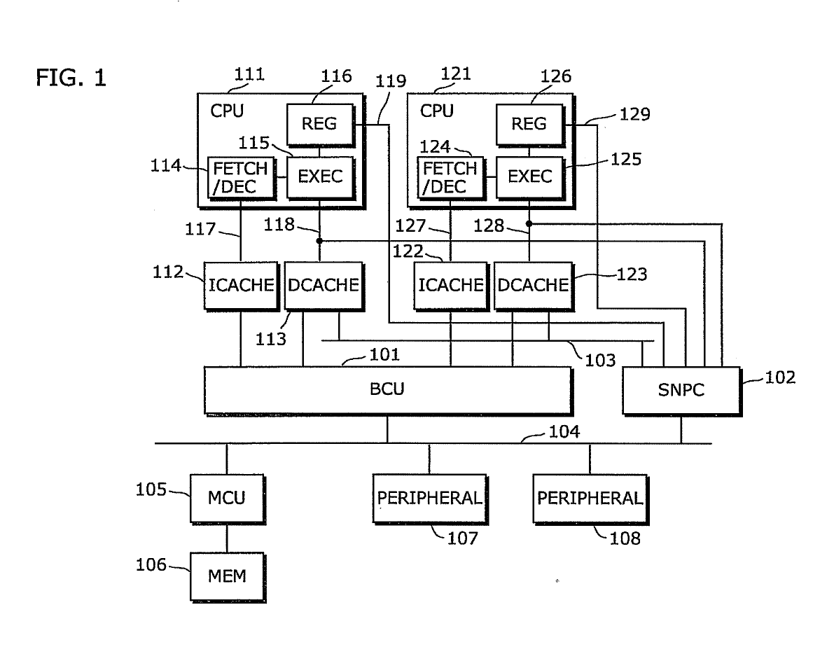

As compared to the conventional multiprocessor system shown in FIG. 1, the processor system shown in FIG. 2 further includes a control signal line 118A but no longer includes the CPU 121, the ICACHE 122, and the DCACHE 123, which relate to the second processor, and the SNPC 102, the snoop bus 103, the signal line 119, and the signal line 129, which relate to the snoop function. In addition, the CPU 111 and the DCACHE 113 are replaced by a CPU 111A and a DCACHE 113A, respectively.

Upon executing several specific instructions, the CPU 111A provides to the request signal line 118 a request signal for requesting access to data according to the instruction, which request signal is of the same sort as a request signal provided upon executing a normal instruction, and moreover, the CPU 111A provides to the control signal line 118A an indication signal indicating that the requested data is a synchronization primitive. These specific instructions are collectively referred to as a synchronization primitive operation instruction.

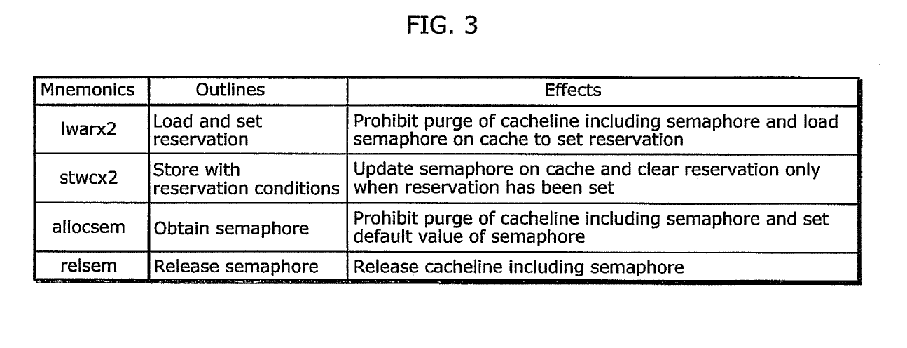

FIG. 3 shows one example of the synchronization primitive operation instruction.

As shown in FIG. 3, instructions lwarx2, stwcx2, allocsem, and relsem are provided as the synchronization primitive operation instruction.

The instructions lwarx2 and the stwcx2 are instructions which are obtained by adding functions of explicitly operating the synchronization primitive (semaphore) located on the cache and the later-described synchronization primitive attribute information to the respective instructions lwarx and stwcx. which are described in the section for related art.

The instructions allocsem and relsem are instructions which are newly proposed in the present invention.

Outlines and effects of the respective instructions are as shown in FIG. 3.

The DCACHE 113A is a cache memory device which is constructed by adding to the well-known structure represented by a 4-way set associative, for example, a function of holding the synchronization primitive attribute information indicating that the data is a valid synchronization primitive, and handling the synchronization primitive attribute information according to the control signal obtained from the control signal line 118A.

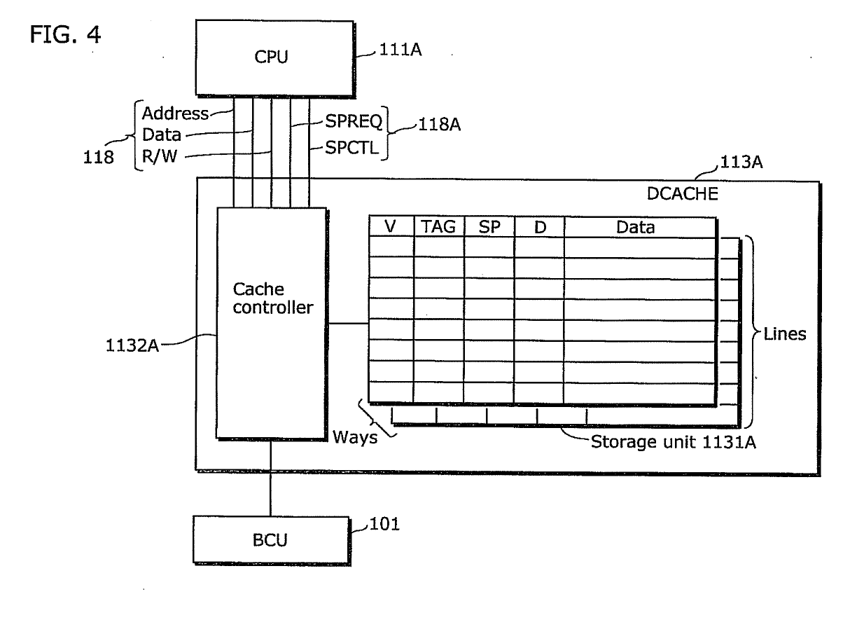

FIG. 4 is a block diagram showing one example of a functional structure of the DCACHE 113A.

As shown in FIG. 4, the DCACHE 113A includes a storage unit 1131A and a cache controller 1132A.

The storage unit 1131A has a synchronization primitive bit SP for each of lines to store the synchronization primitive attribute information. When the synchronization primitive bit SP is set, it indicates that part or all of the data in the line holds a valid synchronization primitive. Valid bit V, tag TAG, dirty bit D, and data are well known as information held in a cache memory device and therefore not described herein.

The cache controller 1132A prohibits purging of the line in which the synchronization primitive bit SP is set, from the DCACHE 113A, by excluding the line from candidates for replace, for example.

The cache controller 1132A receives a request signal through the request signal line 118. The request signal includes, for example, an address signal, a data signal, and an R/W signal indicating either reference or update of data.

Furthermore, the cache controller 1132A receives, through the control signal line 118A, an indication signal indicating that the data requested by the request signal is a synchronization primitive. The indication signal is composed of a SPREQ signal and a SPCTL signal, for example.

The SPREQ signal indicates that the request signal requests loading and storing operation of the synchronization primitive. The SPCTL signal indicates that the request signal requests allocating and releasing operation of the synchronization primitive.

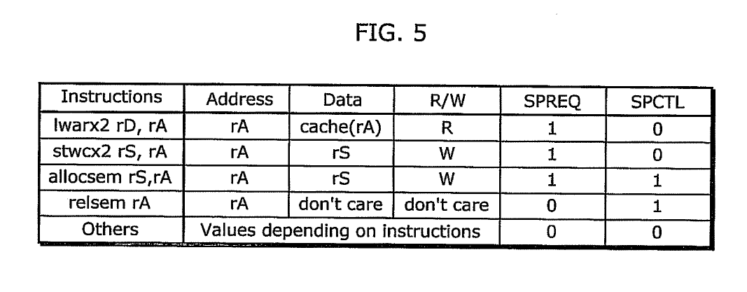

FIG. 5 is a table for explaining association of the instruction with the request signal and the control signal.

The instruction lwarx2 rD, rA means loading the data located at the address rA into the register rD and then obtaining a reservation.

The instruction stwcx2 rS, rA means storing the data which is located in the register rS, at the address rA, and then clearing the reservation. This instruction is a conditional instruction which is executed only when the reservation has been obtained.

The instruction allocsem rS, rA means securing that the data located at the address rA is held in the DCACHE 113A, and storing the value of the register rS at the address rA.

The instruction relsem rA means releasing from the DCACHE 113A the data located at the address rA.

The other instructions are general instructions other than the synchronization primitive operation instruction.

FIG. 5 shows details of the request signals Address, Data, and R/W which are transmitted on the request signal line 118 upon execution of each instruction by the CPU 111A as well as details of the indication signals SPREQ and SPCTL which are transmitted on the control signal line 118A upon execution of each instruction by the CPU 111A.

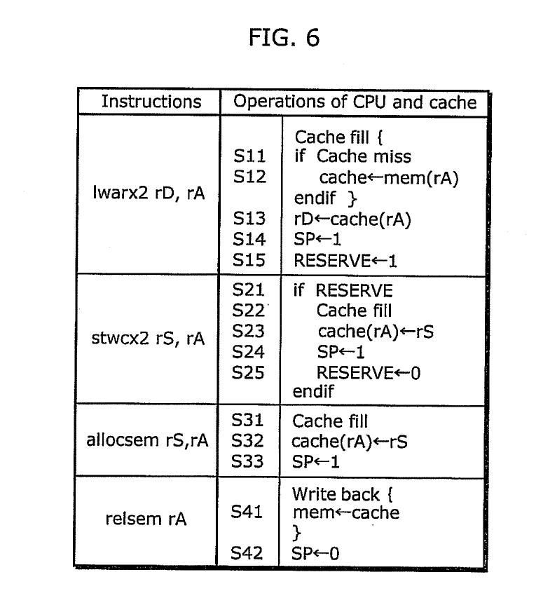

FIG. 6 is a table showing operations of the CPU 111A and the DCACHE 113A for each instruction. The DCACHE 113A operates according to the request signal and the indication signal (cf. FIG. 5) which the CPU 111 provides upon execution of each instruction.

The operations for each instruction will be hereinbelow described in detail. As to the instructions lwarx2 and stwcx2, the common operations to the instructions lwarx and stwcx. will also be described as necessary.

In execution of the instruction lwarx2 rD, rA, a cache fill operation indicated by S11 and S12 is performed first. To be specific, when the data located at the address rA has not been stored in the DCACHE 113A and when even such data has been stored in the DCACHE 113A but a corresponding synchronization primitive bit SP has been cleared, it is determined as a failure (True in S11) and the cache controller 1132A reads line-aligned data located at the address rA and having a length of one line from the MEM 106 through the shared bus 104, and writes the data into a line in the storage unit 1131A of the DCACHE 113A (S12).

The CPU 111A loads the data stored in the part of the DCACHE 113A corresponding to the address rA, into rD (S13). The cache controller 1132A sets the corresponding synchronization primitive bit SP (S14). The CPU 111A sets a RESERVE bit (S15).

In the case where the RESERVE bit has been set at the time of execution of the instruction stwcx2 rS, rA (True in S21), the CPU 111A provides the request signal and the indication signal. The cache controller 1132A performs a cache fill operation which is the same as that performed in S11 and S12 described above (S22).

The cache controller 1132A stores the value of the register rS provided from the CPU 111A, into the part of the DCACHE 113A corresponding to the address rA (S23), and sets the corresponding synchronization primitive bit SP (S24). The CPU 111A clears the RESERVE bit (S25).

Upon executing the instruction allocsem rS, rA, the cache controller 1132A performs a cache fill operation which is the same as that performed in S11 and S12 described above (S31). The cache controller 1132A stores the value of the register rS provided from the CPU 111A, into in the part of the DCACHE 113A corresponding to the address rA (S32), and sets the corresponding synchronization primitive bit SP (S33).

Upon executing the instruction relsem rA, the cache controller 1132A writes the line of DCACHE 113A containing the part corresponding to the address rA back to the MEM 106 (S41), and clears the corresponding synchronization primitive bit SP (S42).

If the line containing the part corresponding to the address rA does not hold valid data except for a semaphore, the write-back operation in S41 may be omitted. To be specific, if a valid bit V has bee cleared and if the valid bit V has been set but a dirty bit D has been cleared, the write-back operation may be omitted.

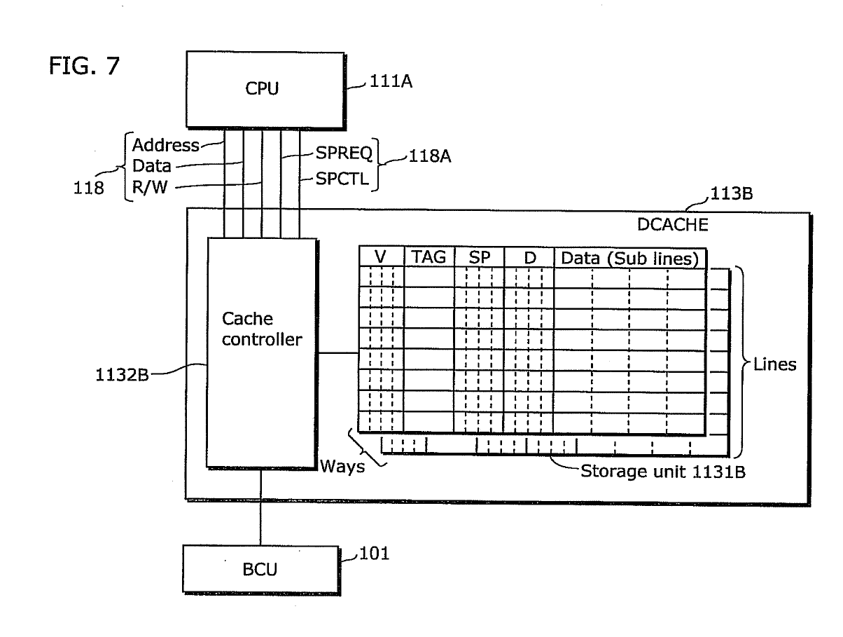

In addition, while the above explanation describes that data and attribute information are managed on a line basis in the DCACHE 113A, the data and the attribute information may be managed on a sub line basis by providing multiple sub lines for one TAG. FIG. 7 is a block diagram showing one example of a functional structure of a DCACHE 113B which manages data and attribute information on a sub line basis.

The DCACHE 113B has a storage unit 1131B in which four sub lines are provided for each TAG and an attribute bit including a so synchronization primitive bit SP is provided for each sub line. A cache controller 1132B updates the data and the attribute information on a sub line basis.

Both the DCACHE 113A managing the data and the attribute information on a line basis (FIG. 4) and the DCACHE 113B managing the data and the attribute information on a sub line basis (FIG. 7) are examples of the cache memory device of the present invention.

Furthermore, the storage unit 1131A and the storage unit 1131B are also examples of the storage unit of the present invention, and the cache controller 1132A and the cache controller 11328 are examples of the obtaining unit and the controller of the present invention.

The following describes one usage example of the synchronization primitive operation instruction in a processor system structured as above.

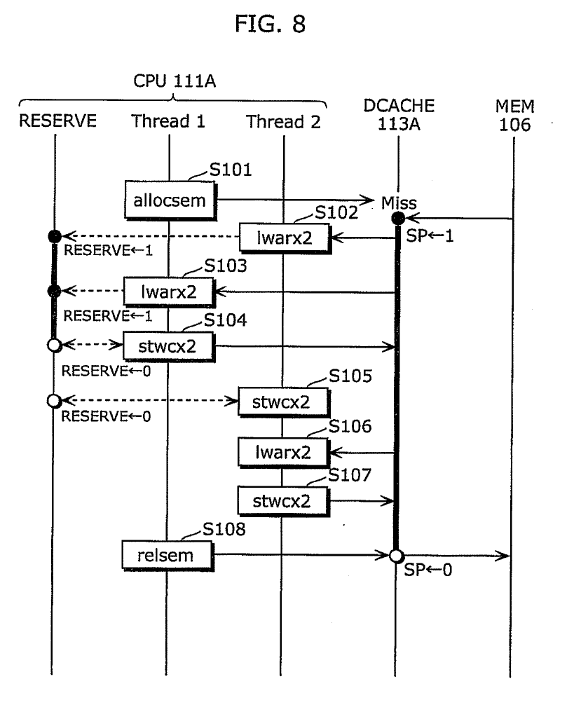

FIG. 8 is a sequence chart for explaining one usage example of the synchronization primitive operation instruction.

The CPU 111A is a multithread processor and therefore capable of executing multiple threads in parallel. In the following description, the synchronization primitive is a semaphore.

(S101) In a thread 1, the instruction allocsem is executed to load line-aligned data located at a semaphore address and having a length of one line from the MEM 106 into a line in the DCACHE 113A. The synchronization primitive bit SP in the corresponding line is set.

In FIG. 8, a solid arrow indicates movement of data to be loaded and to be stored, and a dotted arrow indicates reference and update of RESERVE bit and synchronization primitive bit SP, which accompany with such loading and storing. In addition, for easy understanding, a period in which the RESERVE bit is set and a period in which the synchronization primitive bit is set are indicated by bold lines. These representations are common to FIGS. 8, 11 and 13.

In a thread 2, the instruction allocsem is not executed on the premise that a semaphore is held in a line of the DCACHE 113A owing to the operation in the thread 1.

(S102) In the thread 2, the instruction lwarx2 is executed to read a semaphore at the same semaphore address. In this case, because the DCACHE 113A already retains the semaphore, the semaphore is read out from the DCACHE 113A and loaded into the register of the CPU 111A. The CPU 111A sets a RESERVE bit.

(S103) In the thread 1, the instruction lwarx2 is executed to load a semaphore from the same semaphore address. In this case, because the DCACHE 113A already retains the semaphore, the semaphore is read out from the DCACHE 113A and loaded into the register of the CPU 111A. The CPU 111A maintains the RESERVE bit in a set status.

In the thread 1, the first value for updating the semaphore is calculated, and in the thread 2, the second value for updating the semaphore is calculated.

(S104) The execution of the instruction stwcx2 in the thread 1 causes the first value to be stored in the part of the DCACHE 113A corresponding to the semaphore address because the RESERVE bit has been set. The RESERVE bit in the CPU 111A is cleared by the execution of the instruction stwcx2.

(S105) The execution of the instruction stwcx2 in the thread 2, which is later than the thread 1, results in no semaphore update because the RESERVE bit has been cleared.

(S106, S107) The semaphore can be updated by executing the instructions lwarx2 and stwcx2 anew in the tread 2.

(S108) In the thread 1, the instruction relsem is executed to release a semaphore which is no longer necessary for the reason that the process execution has been completed or the like reason.

As above explained, in the processor system according to the first embodiment, upon execution of the synchronization primitive operation instruction by the CPU 111A, the synchronization primitive bit is set in the DCACHE 113A according to the control signal provided from the CPU 111A. Purge of the data having a synchronization primitive bit set is prohibited so that the synchronization primitive is resident in the DCACHE 113A.

This eliminates the need to move the synchronization primitive between the DCACHE 113A and the MEM 106 (e.g., the write-back operation and the cache fill operation), allowing for an improvement in the performance of synchronization process between processes in a general-purpose processor architecture.

To ensure that the synchronization primitive is resident in the DCACHE 113A, the cache controller 1132A stores the data and the synchronization primitive attribute information into the DCACHE 113A by an atomic operation in response to the request signal provided according to the synchronization primitive operation instruction.

In other words, having received the instruction signal indicating that the data is a synchronization primitive, the cache controller 1132A does not start a process in response to a subsequent request signal until it competes storing the data and the synchronization primitive attribute information into the DCACHE 113A in response to the current request signal.

Alternatively, as another conceivable structure, the above synchronization primitive operation instruction may be replaced by a dedicated instruction for only handling the synchronization primitive attribute information so that the synchronization primitive attribute information is handled with the dedicated instruction and the synchronization primitive data is handled with a general instruction for data loading and storing.

However, the above structure of the present invention is more advantageous than such a conceivable structure in that the number of instructions required for the same result is smaller and in that matching between the synchronization primitive data and the synchronization primitive attribute information can be secured because storing the synchronization primitive data and storing the synchronization primitive attribute information are performed in an atomic manner.

### Second Embodiment

Next, a processor system according to the second embodiment is described.

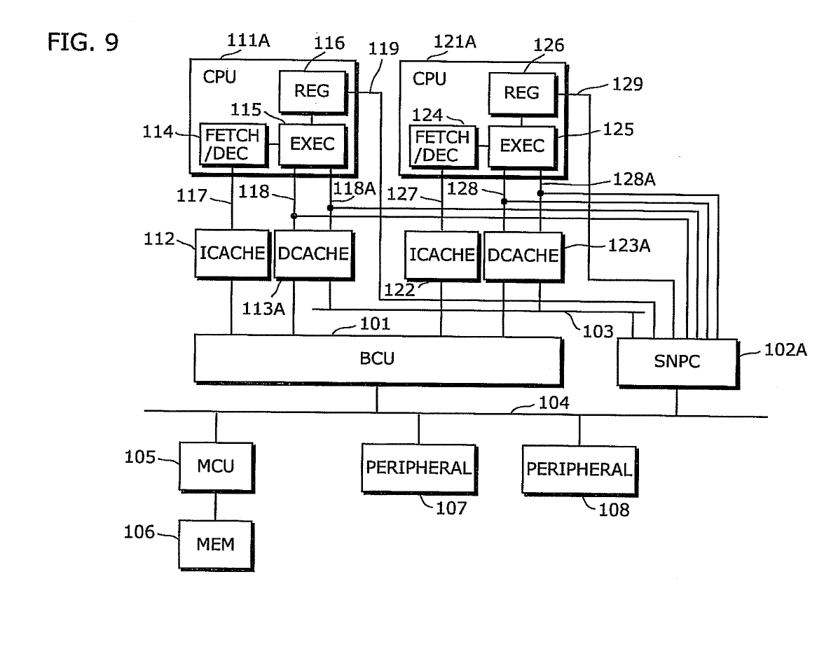

FIG. 9 is a block diagram showing one example of a functional structure of the multiprocessor system according to the second embodiment. This processor system is a processor system which includes two processors (a multi-core processor). The processor system shown in FIG. 9 is implemented as a semiconductor system LSI (SoC) or an information appliance set.

As compared to the conventional multiprocessor system shown in FIG. 1, the processor system shown in FIG. 9 further includes the control signal line 118A and a control signal line 128A. In addition, the CPU 111, the CPU 121, the DCACHE 113, the DCACHE 123, and the SNPC 102 are replaced by the CPU 111A, a CPU 121A, the DCACHE 113A, a DCACHE 123A, and a SNPC 102A, respectively.

Details of the CPU 111A, the DCACHE 113A, and the control signal line 118A are as described in the first embodiment (cf. FIGS. 4 and 5). The CPU 121A, the DCACHE 123A, and the control signal line 128A are structured in the same manner as the CPU 111A, the DCACHE 113A, and the control signal line 118A, respectively.

As compared to the conventional SNPC 102, the SNPC 102 further includes a function of monitoring the control signal line 118A and the control signal line 128A to detect an indication signal and thereby make an adjustment such that the data and the synchronization primitive attribute information in the DCACHE 113A and the DCACHE 123A stay coherent.

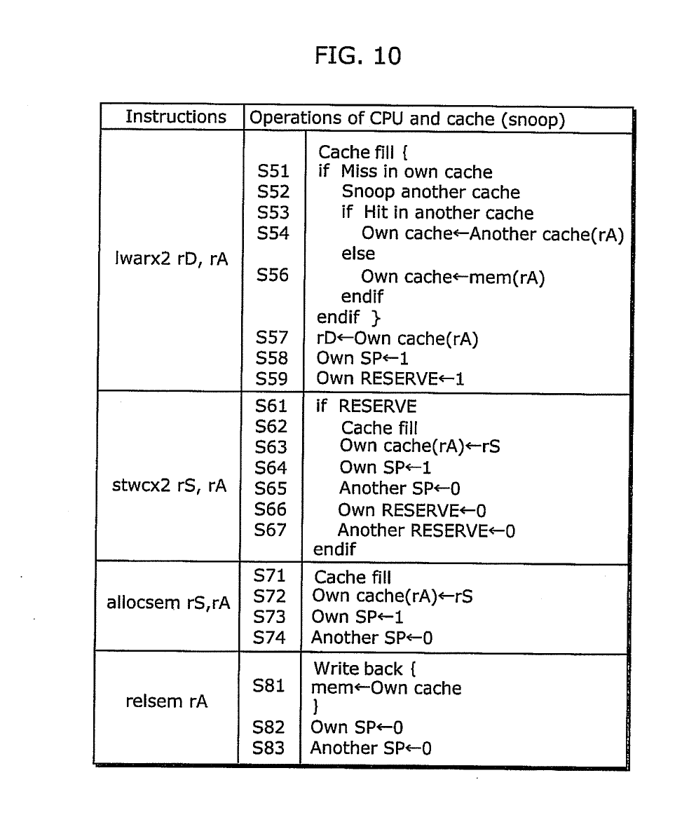

FIG. 10 is a table showing operations of the CPU 111, the CPU 121A, the DCACHE 113A, the DCACHE 123A, and the SNPC 102A for each instruction. The DCACHE 113A, the DCACHE 123A, and the SNPC 102A operate according to the request signal and the indication signal which the CPU 111A provides upon execution of each instruction.

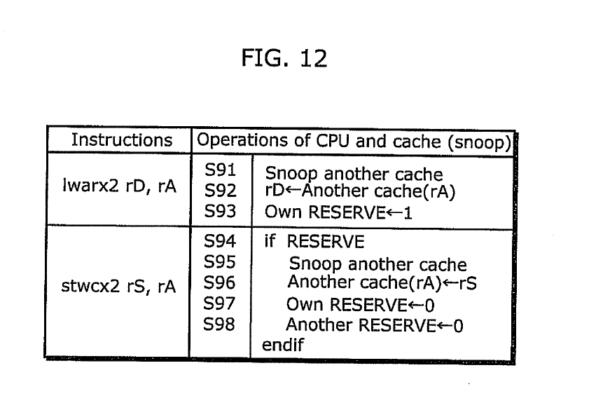

In FIG. 10, of the CPU 111A, the CPU 121A, the DCACHE 113A, and the DCACHE 123A, an element relating to a processor which executes the current instruction is denoted by “own” and an element relating to a processor which does not execute the current instruction is denoted by “another”. These representations are common to FIGS. 10 and 12.

The operation for each instruction will be hereinbelow described in detail. As to the instructions lwarx2 and stwcx2, the common operation to the instructions lwarx and stwcx. will also be described as necessary.

The following description applies to the case where the instruction is executed by the CPU 111A. In the case where the instruction is executed by the CPU 121A, the CPU 111A and the DCACHE 113A in the following description are replaced by the CPU 121A and the DCACHE 123A, respectively.

In execution of the instruction lwarx2 rD, rA, a cache fill operation indicated by S51 to S56 is performed first. To be specific, when the address rA misses in the DCACHE 113A (True in S51), the SNPC 102A snoops the DCACHE 123A (S52).

When the address rA hits in the DCACHE 123A (True in S53), the SNPC 102A reads out the data of the line containing the address rA from the DCACHE 123A and writes the data into one line of the DCACHE 113A (S54).

On the other hand, when the address rA does not hit in the DCACHE 123A (False in S53), the cache controller 1132A reads out the line-aligned data located at the address rA and having a length of one line from the MEM 106 through the shared bus 104 and writes the data into one line (S56).

The CPU 111A loads the data stored in a part of the DCACHE 113 corresponding to the address rA, into rD (S57). The cache controller 1132A sets the corresponding synchronization primitive bit SP (S58). The CPU 111A sets a RESERVE bit (S59).

In the case where the RESERVE bit has been set at the time of execution of the instruction stwcx2 rS, rA (True in S61), the CPU 111A provides the request signal and the indication signal. The SNPC 102A and the cache controller 1132A perform a cache fill operation which is the same as that performed in S51 to S56 described above (S62).

The cache controller 1132A causes the value of the register rS provided from the CPU 111A to be stored in the part of the DCACHE 113A corresponding to the address rA (S63), and sets the corresponding synchronization primitive bit SP (S64). If there is a synchronization primitive bit SP corresponding to the address rA in the DCACHE 123A, the SNPC 102A clears the synchronization primitive bit SP (S65).

The CPU 111A clears the RESERVE bit (566). The SNPC 102A clears the RESERVE bit in the CPU 121A (S67).

Upon executing the instruction allocsem rS, rA, the SNPC 102A and the cache controller 1132A perform a cache fill operation which is the same as that performed in S51 to S56 described above (S71). The cache controller 1132A stores the value of the register rS of the CPU 111A into the part of the DCACHE 113A corresponding to the address rA (S72) and sets the corresponding synchronization primitive bit SP (S73). If there is a synchronization primitive bit SP corresponding to the address rA in the DCACHE 123A, the SNPC 102A clears the synchronization primitive bit SP (S74).

Upon executing the instruction relsem rA, the cache controller 1132A writes the line of DCACHE 113A containing the part corresponding to the address rA back to the MEM 106 (S81), and clears the corresponding synchronization primitive bit SP (S82). If there is a synchronization primitive bit SP corresponding to the address rA in the DCACHE 123A, the SNPC 102A clears the synchronization primitive bit SP (S83).

If the line containing the part corresponding to the address rA does not hold valid data except for a semaphore, the write-back operation in S81 may be omitted. To be specific, if a valid bit V has bee cleared and if the valid bit V has been set but a dirty bit D has been cleared, the write-back operation may be omitted.

While the above explanation describes that data and attribute information are managed on a line basis in the DCACHE 113A and the DCACHE 123A, the data and the attribute information may be managed on a sub line basis by providing multiple sub lines for one TAG.

The following describes one usage example of the synchronization primitive operation instruction in a processor system structured as above.

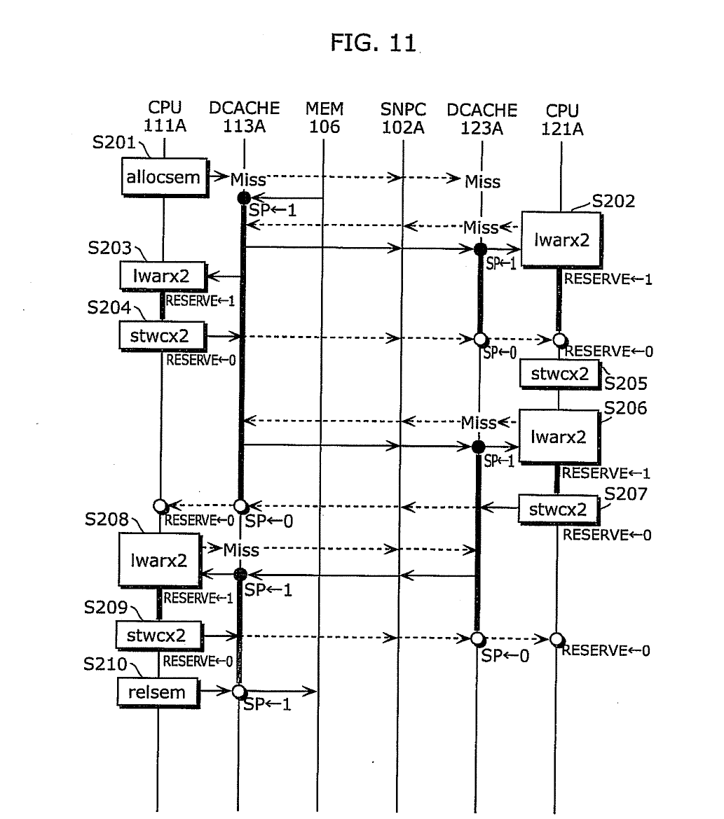

FIG. 11 is a sequence chart for explaining one usage example of the synchronization primitive operation instruction.

(S201) The CPU 111A executes the instruction allocsem to load line-aligned data located at a semaphore address and having a length of one line from the MEM 106 into a line in the DCACHE 113A. The synchronization primitive bit SP in the corresponding line is set. The CPU 121A does not execute the instruction allocsem on the premise that the synchronization primitive is held in a line of the DCACHE 113A owing to the operation of the CPU 111A.

(S202) The CPU 121A executes the instruction lwarx2 to load a semaphore designated by the same semaphore address. The semaphore addresses misses in the DCACHE 123A.

The SNPC 102 detects that the semaphore is included in the DCACHE 113A, then copies the corresponding line of the DCACHE 113 onto one line of the DCACHE 123A via the snoop bus 103 and sets the synchronization primitive attribute information of the line containing the semaphore of the DCACHE 123A.

The CPU 121A reads out the semaphore from the corresponding line of the DCACHE 123A and loads the semaphore into the register. The CPU 121A sets a RESERVE bit.

(S203) The CPU 111A executes the instruction lwarx2 to load a semaphore designated by the same semaphore address. The semaphore addresses hits in the DCACHE 113A.

The CPU 111A reads out the semaphore from the corresponding line of the DCACHE 113A and loads the semaphore into the register. The CPU 111A sets a RESERVE bit.

The CPU111A and the CPU 121A calculate the first value and the second value, respectively, for updating the semaphore.

(S204) The execution of the instruction stwcx2 by the CPU 111A causes the first value to be stored in the corresponding line of the

DCACHE 113A because the RESERVE bit has been set. The CPU 111A clears the RESERVE bit.

The SNPC 102A detects that the semaphore is included in the DCACHE 123A, and clears the synchronization primitive attribute information in the corresponding line of the DCACHE 123A. The SNPC 102A clears the RESERVE bit in the CPU 121A.

(S205) The execution of the instruction stwcx2 by the CPU 121A, which is later than the execution by the CPU 111A, results in no semaphore update because the RESERVE bit has been cleared.

(S206) The CPU 121A executes the instruction lwarx2 anew to load a semaphore designated by the same semaphore address. The semaphore address misses in the DCACHE 123A because the synchronization primitive attribute information in the corresponding line of the DCACHE 123A has been cleared in 5204. Then, the same processing as S202 is performed.

(S207) The execution of the instruction stwcx2 by the CPU 121A causes the second value to be stored in the corresponding line of the DCACHE 113A because the RESERVE bit has been set. The CPU 121A clears the RESERVE bit.

The SNPC 102A detects that the semaphore is included in the DCACHE 113A and clears the synchronization primitive attribute information in the corresponding line of the DCACHE 113A. The SNPC 102A clears the RESERVE bit in the CPU 111A.

(S208) The CPU 111A executes the instruction lwarx2 to load a semaphore designated by the same semaphore address. The semaphore address misses in the DCACHE 113A because the synchronization primitive bit SP of the corresponding line of the DCACHE 123A has been cleared in S207.

The SNPC 102 detects that the semaphore is included in the DCACHE 123A, then copies the corresponding line of the DCACHE 113 onto one line of the DCACHE 113A via the snoop bus 103 and sets the synchronization primitive attribute information of the line containing the semaphore of the DCACHE 113A.

The CPU 111A reads out the semaphore from the corresponding line of the DCACHE 113A and loads the semaphore into the register. The CPU 111A sets a RESERVE bit.

(S209) The execution of the instruction stwcx2 by the CPU 111A causes the first value to be stored in the corresponding line of the DCACHE 113A because the RESERVE bit has been set. The CPU 111A clears the RESERVE bit.

The SNPC 102A detects that the semaphore is included in the DCACHE 123A and clears the synchronization primitive attribute information in the corresponding line of the DCACHE 123A. The SNPC 102A clears the RESERVE bit in the CPU 121A.

(S210) The CPU 111A executes the instruction relsem to release a semaphore which is no longer necessary for the reason that the process execution has been completed or the like reason.

As above explained, in the processor system according to the second embodiment, upon execution of the synchronization primitive operation instruction by the CPU 111A and the CPU 121A, the synchronization primitive attribute information is set in the DCACHE 113A and the DCACHE 123A according to the control signal provided from the CPU 111A and the CPU 121A. In addition, upon update of the synchronization primitive in one of the DCACHE 113A and the DCACHE 123A, the SNPC 102A clears the synchronization primitive attribute information in the other one of the DCACHE 113A and the DCACHE 123A.

This prevents the synchronization primitive having the latest value with the synchronization primitive attribute information set from being purged so that the synchronization primitive is resident in at least one of the DCACHE 113A and the DCACHE 123A. When necessary, the latest value of the synchronization primitive is used, via the snoop bus 103, in the fill operation for the other synchronization primitive (having an old value) with the synchronization primitive attributed information cleared.

This eliminates the need to move the synchronization primitive between the DCACHE 113A and the MEM 106 and between the DCACHE 123A and the MEM 106 (e.g., the write-back operation and the cache fill operation), allowing for an improvement in the performance of synchronization process between processes in a general-purpose processor architecture.

To ensure that the synchronization primitive is resident in at least one of the DCACHE 113A and the DCACHE 123A, the SNPC 102A adjusts the data and the synchronization primitive attribute information in the DCACHE 113A and in the DCACHE 123A by an atomic operation in response to the request signal provided according to the synchronization primitive operation instruction.

In other words, having received the instruction signal indicating that the data is a synchronization primitive, the SNPC 102A does not start a process in response to a subsequent request signal until it competes adjusting the data and the synchronization primitive attribute information in the DCACHE 113A and in the DCACHE 123A in response to the current request signal. Such a control can be achieved generally by providing the SNPC 102A with a buffer (queue) where a subsequent request signal waits.

Alternatively, as another conceivable structure, the above synchronization primitive operation instruction may be replaced by a dedicated instruction for only handling the synchronization primitive attribute information so that the synchronization primitive attribute information is handled with the dedicated instruction and the synchronization primitive data is handled with a general instruction for data loading and storing.

However, the above structure of the present invention is more advantageous than such a conceivable structure in that the number of instructions required for the same result is smaller and in that matching between the synchronization primitive data and the synchronization primitive attribute information can be secured because adjusting the synchronization primitive data and adjusting the synchronization primitive attribute information are performed in an atomic manner.

The above explanation describes that, upon update of the synchronization primitive in one of the DCACHE 113A and the DCACHE 123A, the SNPC 102A clears the synchronization primitive attribute information in the other one of the DCACHE 113A and the DCACHE 123A (e.g., S204, S207, and S209).

However, upon update of the synchronization primitive in one of the DCACHE 113A and the DCACHE 123A, the SNPC 102A may update the synchronization primitive in the other one of the DCACHE 113A and the DCACHE 123A to the updated value and may set the other synchronization primitive attribute information.

With this structure, the latest synchronization primitives are resident in both of the DCACHE 113A and the DCACHE 123A, which allows that the CPU 111A and the CPU 121A to receive quick responses to the synchronization primitive operation instructions from the DCACHE 113A and the DCACHE 123A.

### Third Embodiment

Next, a processor system according to the third embodiment is described.

The processor system according to the third embodiment is different from the processor system explained in the second embodiment in that the synchronization primitive is resident only in the DCACHE 113A. This leads to a change in the operation performed when the CPU 121A executes the synchronization primitive operation instruction.

In this structure, the DCACHE 123A is provided as a cache memory device dedicated to data other than a synchronization primitive and thus ignores a request signal when an indication signal indicating that the data is a synchronization primitive is given. It is also possible to omit the DCACHE 123A.

FIG. 12 is a table showing operations of the CPU 121A, the DCACHE 113A, and the SNPC 102A for each instruction. The DCACHE 113A and the SNPC 102A operate according to the request signal and the indication signal which the CPU 121A provides upon execution of each instruction.

The operation for each instruction will be hereinbelow described in detail. As to the instructions lwarx2 and stwcx2, the common operation to the instructions lwarx and stwcx. will also be described as necessary.

The following description applies to the case where the instruction is executed by the CPU 121A. In the case where the instruction is executed by the CPU 111A, the operations explained in the second embodiment (cf. FIG. 10) except the operation for another cache (namely the DCACHE 123A) are performed.

In execution of the instruction lwarx2 rD, rA, the SNPC 102A snoops the DCACHE 113A to obtain data stored in the part of the DCACHE 113A corresponding to the address rA (S91), and the CPU 121A loads the data obtained by the SNPC 102A, into rD (S92). The CPU 121A sets a RESERVE bit (S93).

In the case where the RESERVE bit has been set at the time of execution of the instruction stwcx2 rS, rA (True in S94), the CPU 121A provides the request signal and the indication signal. The SNPC 102A snoops the DCACHE 113A (S95) and stores the value of the register rS provided from the CPU 121A, into the part of the DCACHE 113A corresponding to the address rA (S96).

The CPU 121A clears the RESERVE bit (S97). The SNPC 102A clears the RESERVE bit in the CPU 111A (S98).

The following describes one usage example of the synchronization primitive operation instruction in a processor system structured as above.

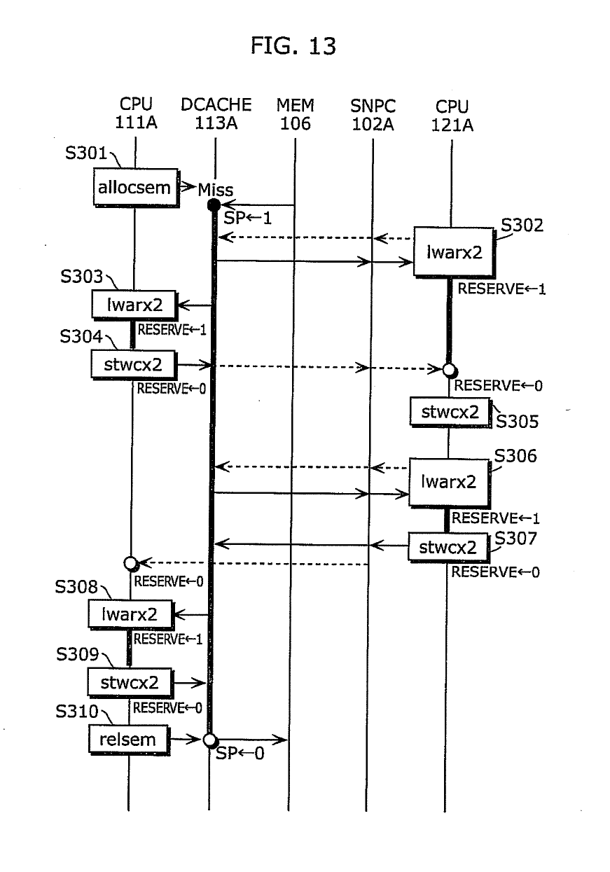

FIG. 13 is a sequence chart for explaining one usage example of the synchronization primitive operation instruction. The following primarily describes differences from the explanations of the sequence chart of FIG. 11 without repeating their overlapping descriptions unless necessary.

(S301) The same as S201.

(S302) The CPU 121A executes the instruction lwarx2 to load a semaphore designated by the same semaphore address. The DCACHE 123A ignores a request signal provided from the CPU 121A. The SNPC 102 obtains a semaphore from the DCACHE 113A through the snoop bus 103, and the CPU 121A reads out the semaphore from the SNPC 102 and loads it into the register. The CPU 121A sets a RESERVE bit.

(S303 to S305) The same as 5203 to S205.

(S306 to S307) The CPU 121A executes the instructions lwarx2 and stwcx2 anew. The DCACHE 123A ignores a request signal provided from the CPU 121A. The semaphore designated by the semaphore address is taken out from the SNPC 102A through the snoop bus 103 and written into the DCACHE 113A.

(S308 to S310) The same as S208 to 5210.

As described above, in the processor system according to the third embodiment, the synchronization primitive is resident in the DCACHE 113A, and upon execution of the synchronization primitive operation instruction by the CPU 121A, the data and the synchronization primitive attribute information in the DCACHE 113A is handled by the SNPC 102A via the snoop bus 103.

This eliminates the need to move the synchronization primitive between the DCACHE 113A and the MEM 106 (e.g., the write-back operation and the cache-fill operation), allowing for an improvement in the performance of synchronization process between processes in a general-purpose processor architecture.

However, it is possible that keeping the synchronization primitive resident in the cache memory device is determined as being disadvantageous in performance, for example, when the synchronization process between processes is not frequent. In such a case, the above-described instructions lwarx2 and stwcx2 may be replaced by the conventional instructions lwarx and stwcx.

By so doing, the synchronization primitive will not be resident in the cache memory device, with the result that the cache memory device can be used also to improve accessibility to data other than the synchronization primitive.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The cache memory device and the processor system including the cache memory device according to the present invention are, for example, incorporated into a digital information device, a mobile communication device, and the like, and thus useful as a control microprocessor or microcontroller which is powered by a battery. In addition, they are also applicable to built-in LSI and DSP for DMA control.

What is claimed is:

1. A cache memory device which stores a copy of data to be stored in a main memory and provides the copy as accessed from a central processing unit, said cache memory device comprising:
a storage unit in which the data and attribute information can be stored in association with each other;
an obtaining unit configured to obtain a request signal and an indication signal from the central processor, the request signal requesting access to the data, and the indication signal indicating whether or not the requested data is a synchronization primitive; and
a control unit configured to store, into said storage unit, the requested data and synchronization primitive attribute information in association when the indication signal indicates that the data requested by the request signal is the synchronization primitive, the synchronization primitive attribute information indicating that the requested data is a valid synchronization primitive.

2. The cache memory device according to claim 1,
wherein said control unit is further configured to prohibit purge of the data stored in said storage unit in association with the synchronization primitive attribute information.

3. The cache memory device according to claim 1,
wherein said control unit is further configured to perform an atomic operation in response to the request signal, to store, into said storage unit, the requested data and the synchronization primitive attribute information in association with each other.

4. A processor system comprising:
said cache memory device according to claim 1; and
a central processor which provides a request signal and an indication signal to said cache memory device in executing a specific instruction, the request signal requesting access to data indicated by the specific instruction, and the indication signal indicating that the requested data is a synchronization primitive.

5. A cache memory system comprising:
a first cache memory device that is said cache memory device according to claim 1;
a second cache memory device that is said cache memory device according to claim 1; and
a snoop device connected to said first cache memory device and said second cache memory device, said snoop device (i) monitoring a request signal and an indication signal which are provided to each of said cache memory devices, and when the request signal and the indication signal are detected, (ii) making an adjustment according to the detected request signal and the detected indication signal such that coherency of data and synchronization primitive attribute information stored in each of said cache memory devices is maintained.

6. The cache memory system according to claim 5,
wherein said snoop device performs an atomic operation in response to the detected request signal, to make the adjustment such that the coherency of the data and the synchronization primitive attribute information stored in each of said cache memory devices is maintained.

7. The cache memory system according to claim 5,
wherein in the case where the request signal requesting update of first data located at a first address to second data and the indication signal indicating that the second data is a synchronization primitive are provided to said second cache memory device when the first data and the synchronization primitive attribute information associated so with the first data are stored in said first cache memory device, said snoop device deletes the synchronization primitive attribute information stored in said first cache memory device.

8. The cache memory system according to claim 5,
wherein in the case where the request signal requesting update of first data located at a first address to second data and the indication signal indicating that the second data is a synchronization primitive are provided to said second cache memory device when the first data and the synchronization primitive attribute information associated with the first data are stored in said first cache memory device, said snoop device updates the first data stored in said first cache memory device to the second data.

9. The cache memory system according to claim 5,
wherein in the case where the request signal requesting update of first data located at a first address to second data and the indication signal indicating that the second data is a synchronization primitive are provided to said second cache memory device, said second cache memory device stops storing the second data and the synchronization primitive attribute information associated with the second data, and said snoop device stores, into said first cache memory device, the second data and the synchronization primitive attribute information associated with the second data.

10. The cache memory system according to claim 5,
wherein in the case where the request signal requesting reference of first data located at a first address and the indication signal indicating that the data is a synchronization primitive are provided to said second cache memory device when the first data and the synchronization primitive attribute information associated with the first data are stored in said first cache memory device, said snoop device obtains the first data from said first cache memory device and stores, into said second cache memory device, the obtained first data and the synchronization primitive attribute information associated with the first data, and said second cache memory device provides the stored first data in response to the request signal.

11. The cache memory system according to claim 5,
wherein in the case where the request signal requesting reference of first data located at a first address and the indication signal indicating that the data is a synchronization primitive are provided to said second cache memory device when the first data and the synchronization primitive attribute information associated with the first data are stored in said first cache memory device, said snoop device obtains the first data from said first cache memory device and provides the obtained first data in response to the request signal.

12. A processor system comprising:
said cache memory system according to claim 5; and
more than one central processor which is provided to a corresponding one of cache memory devices included in said cache memory system and provides a request signal and an indication signal to said corresponding one of cache memory devices in executing a specific instruction, the request signal requesting access to data indicated by the specific instruction, and the indication signal indicating that the requested data is a synchronization primitive.
